(19) United States
(12) Patent Application Publication
(10) Pub. No.: US 2020/0302319 A1
(43) Pub. Date: Sep. 24, 2020

(54) FUZZY INFERENCE SEARCHING OF ARCHIVED AND OPERATIONAL INFORMATION IN A COMPUTING ENVIRONMENT

(71) Applicant: HEWLETT PACKARD ENTERPRISE DEVELOPMENT LP, Houston, TX (US)

(72) Inventors: Devon L. Dawson, Rocklin, CA (US); David L. Santos, Granite Bay, CA (US); John A. Powell, Granite Bay, CA (US)

(21) Appl. No.: 16/361,368

(22) Filed: Mar. 22, 2019

(51) Int. Cl. G06N 5/04; G06F 16/953; G06F 11/34

(52) U.S. Cl. CPC G06N 5/048; G06F 11/3476; G06F 16/953

(57) ABSTRACT

An administrative tool for use in a computing system includes: an interface through which, in operation, a user may enter a search query for information pertaining to the operation of the computing system; a knowledge base containing fuzzy logic rules about the operation of the computing system; and an inferencing engine that, in operation, applies the fuzzy logic rules to the information responsive to the search query; and return results through the interface.

### BACKGROUND

Computing systems, such as computer networks, have now become sufficiently large that their effective management includes many automated tools and techniques. Large amounts of data are generated, much of it is archived, and still more is formulated into various reports, notices, and alarms. The reports, notices, and alarms are also usually archived. Users, such as administrators, then use the data to make decisions. The data is usually numerical in nature rather than qualitative. That is, the data might yield a particular number measuring some aspect of the computing system's operation, but in and of itself, it does not indicate if that number represents a desirable operational state or an undesirable operational state. Some management systems for computing systems formulate data into reports that place the quantitative data into a qualitative context for the user.

### BRIEF DESCRIPTION OF THE DRAWINGS

Examples described herein may be understood by reference to the following description taken in conjunction with the accompanying drawings, in which like reference numerals identify like elements.

FIG. 1 depicts one particular example of a computing system operated and managed in accordance with the present disclosure,

FIG. 2 depicts selected portions of the hardware and software architecture of the administrative console in the computing system of FIG. 1.

FIG. 3 illustrates a method practiced in accordance with one or more examples disclosed herein.

FIG. 4 depicts one particular example of a computing system operated and managed in accordance with the present disclosure.

FIG. 5 depicts selected portions of an administrative tool as deployed in the computing system of FIG. 4.

FIG. 6 depicts an information store as may be deployed in the computing system of FIG. 4.

FIG. 7 depicts one particular example of a computing system operated and managed in accordance with the present disclosure.

FIG. 8 depicts selected portions of an administrative tool as deployed in the computing system of FIG. 7.

FIG. 9 depicts an information store as may be deployed in the computing system of FIG. 7.

FIG. 10 depicts one particular example of a computing system operated and managed in accordance with the present disclosure.

FIG. 11 depicts selected portions of an administrative tool as deployed in the computing system of FIG. 10.

FIG. 12 depicts an information store as may be deployed in the computing system of FIG. 10.

While examples described herein are susceptible to various modifications and alternative forms, the drawings illustrate specific examples herein described in detail by way of example. It should be understood, however, that the description herein of specific examples is not intended to be limiting to the particular forms disclosed, but on the contrary, the intention is to cover all modifications, equivalents, and alternatives falling within the spirit and scope of the examples described herein and the appended claims.

### DETAILED DESCRIPTION

Illustrative examples of the subject matter claimed below will now be disclosed. In the interest of clarity, not all features of an actual implementation are described in this specification. It may be appreciated that in the development of any such actual example, numerous implementation-specific decisions may be made to achieve the developers' specific goals, such as compliance with system-related and business-related constraints, which will vary from one implementation to another. Moreover, it may be appreciated that such a development effort, even if complex and time-consuming, would be a routine undertaking for those of ordinary skill in the art having the benefit of this disclosure.

It is sometimes useful to search for information regarding computing system operations in a qualitative fashion. The administrator might not be interested so much what the exact value a certain operational parameter is as whether that parameter represents a desirable or undesirable state, for instance. The need to search using particular numbers then perhaps involves multiple searches and, as importantly, knowledge on the part of the administrator to as to what numerical values constitute “desirable” and “undesirable”.

For example, an administrator might perform a search for Central. Processor Unit (“CPU”) usage with a query like:

Find all “CPU>THRESHOLD”

But there may be contexts in which a CPU usage that exceeds the THRESHOLD may be considered “high” and others in which it might be considered “low”, The search query is incapable of such nuance.

The present disclosure improves the ability of administrators (and other users) to obtain contextually useful answers when searching for information in a computing system by employing fuzzy logic. Fuzzy logic has been described as “many-valued logic” as opposed to “binary logic”. Binary logic systems return a single “truth value”, or an answer that is either matches the search logic or does not. Search logic that yields a numerical value, for example, is “binary”. This is sometimes also called “crisp” in the context of fuzzy logic. Fuzzy logic, however, permits multiple matches to the search logic and permits more contextually useful information. For example, it can indicate whether a certain operating parameter is “high”, “low”, or “acceptable”—that is, fuzzy logic can yield an answer that is actually a degree of truth rather than a crisp indication of truth.

The fuzzy logic system of the present disclosure includes input variables, output variables, membership functions defined over the variables' ranges, and fuzzy rules or propositions relating inputs to outputs through the membership functions. The aggregation of all rules is the basis for the fuzzy logic inferencing process. The rules are applied to the input variables using an inferencing engine in light of the membership function and results in the output variable.

Fuzzy logic or Fuzzy inference can be used to enable and/or improve that ability of a human operator or other computing system to search a database of potentially disparate data types using human friendly language semantics. In brief, fuzzy logic allows for fairly complex heuristics to be described in terms that are easier to understand (e.g., “find all EDGE_DEVICES with VERY HIGH CPU AROUND [day/time]”) with less domain knowledge than traditional discrete rules. The domain expertise (a.g., what is HIGH for a CPU) are encoded in the fuzzy “sets” or semantics (e.g., “LOW”, “HIGH”) and these sets can be adjusted at will by the rule writer with human understandable modifiers in the rule such as, “VERY”, “NOT VERY”, “SOMEWHAT”, “ABOUT”, “MORE_OR_LESS”, “ABOVE”, “BELOW”. Without the ability to use the fuzzy sets and modifiers many rules would need to be written to cover the same search in a way that, gives a weighted measure of how well each searched for item matches the rule (e.g., “find all EDGE_DEVICES with CPU >=70 AND <80” “find all EDGE DEVICES with CPU>=80 AND <90”, “find all EDGE_DEVICES with CPU>=90 AND <100”) and each of those respective search results would be given the same resulting score, resulting in no distinction between a device with a CPU of 660% and one with a CPU of 69%. Furthermore, the concept of “AROUND [day/time]” from the sample fuzzy rule would need to be defined crisply as all distinct dates and times that may contain what the rule writer is searching for. Anything even one second outside those ranges would not be included in the result.

The examples disclosed herein execute instructions to search information to meet queries input by a user such as a network administrator. Examples include inferencing on fuzzy logic rules to a metric from one or more managed devices to produce a variable fuzzy based rule expression. The metrics used in the present disclosure can be either stored or real-time. The real-time metrics may be periodically streamed (i.e., unsolicited) or requested (i.e., solicited).

The variable fuzzy based rule expression can then be used as, an input parameter to a fuzzy rule-based heuristic, The fuzzy rule-based heuristic, can then provide information associated with the health of the network device and/or the overall health of the network. In some examples, the variable output from a fuzzy rule-based heuristic can be used as an input parameter to another fuzzy rule-based heuristic. In this manner, variable outputs from several fuzzy rule-based heuristics can be combined to provide information in response to queries entered by the user.

This approach provides nuance to information gathering and analysis in a computing environment by using fuzzy logic inferencing in addition to, or in lieu of, the crisp rules currently in place. The search query may incorporate elements of the fuzzy logic analysis or may be entered in natural language and then translated into a query incorporating elements of fuzzy logic. The results of the fuzzy logic analysis are returned to the user through the interface into which the search query is entered. The search results produce a more nuanced look at how the computing system is operating. The invention also helps transfer the expertise from the administrator to the system. The invention operates on information that is already gathered so that there is no need to actually gather the information.

In one example, an administrative tool includes an interface through which, in operation, a user may enter a search query for information pertaining to an operation of a computing system; a knowledge base containing fuzzy logic rules about computing system operation; and an inferencing engine that, in operation, applies the fuzzy logic rules to the information responsive to the search query and return results through the interface.

In another example, an administrative console includes: a display; an input device; a processing resource; a bus system; and a memory. The memory communicates with the processing resources over the bus systems. The memory is also encoded, with instructions that, when executed by the processing resource, cause the processing resource to: receive a search query for information pertaining to an operation of a computing system that has been gathered, the search query being input using the display and the input device; access the information responsive to the received search query; inferencing on a set of fuzzy logic rules and the accessed information to obtain results to the received search query; and return the results of the fuzzy logic analysis.

In still another example, a method includes: receiving a search query for information pertaining to an operation of a computing system that has been gathered; accessing the information responsive to the received search query; inferencing on a set of fuzzy logic rules and the accessed information to obtain results to the received search query; and returning the results of the fuzzy logic analysis.

In yet another example, a non-transitory computer-readable medium encoded with instructions that, when executed by a processing resource, cause the processing resource to: receive a search query for information pertaining to an, operation of a computing system that has been gathered; access the information responsive to the received search query; inferencing on a set of fuzzy logic rules and the accessed, information to obtain results to the received search query; and return the results of the fuzzy logic analysis.

In still another example, a computing system includes: a plurality of managed devices; a set of information regarding the operation of the managed devices, the information including operating information for the managed devices; and an administrative tool. The administrative tool further includes: an interface through which, in operation, a user may enter a search query for information, pertaining to the operation of the computing system; a knowledge base containing fuzzy logic rules about the operation of the computing system; and an inferencing engine that, in operation, applies the fuzzy logic rules to the information responsive to the search query and return results through the interface.

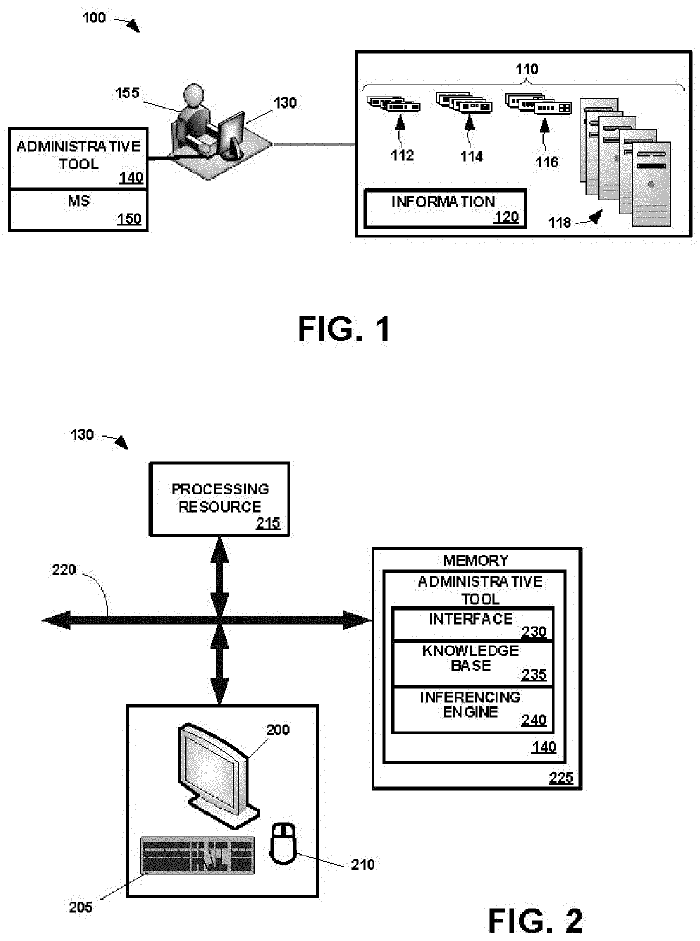

Turning now to the drawings, FIG. 1 depicts one particular example of a computing system 100 operated and managed in accordance with the present disclosure. The computing system 100 may be a network, but the subject matter claimed below is not so limited. The computing system 100 includes, in this particular example, a plurality of managed devices 110, a set of information 120 regarding the operation of the managed devices 110, an administrative console 130, and an administrative tool 140. Some examples will also include a management system (“MS”) 150 residing on the administrative console 130, Those in the art having the benefit of this disclosure will appreciate that many implementation specific details have been omitted for the sake of clarity and so as not to obscure that which is claimed below.

The managed devices 110 may include devices such as, for instance, switches 112, bridges 114, routers 116, and servers 118. However, this list is representative only and is neither exhaustive nor limiting. The managed devices 110 may include any device that is managed in the sense the data is generated that is indicative of its operation and status and that such data may be gathered for management, purposes.

The information 120 may vary widely in nature and location. For example, some of the information 120 may be logged data from the operation of the managed devices 110. The information may be archived data, such as archived plans that have already been implemented. A “plan” is a set of operating parameters used to configure a plurality of managed devices 110 in a large group. So, for instance, the switches 112 may all be reconfigured at one time and the configuration parameters will, collectively, define the “plan.” Such plans are routinely archived for future reference. However, not all of the, information 120 will necessarily be stored. Some of the information 120 may be gathered in real time through the management system 150.

The management system 150 is shown as a single entity residing on the administrative console 130. Those in the art having the benefit of this disclosure will appreciate that this typically will not be the case. Management systems such as the management system 150 typically include many constituent parts distributed throughout the computing system 100. The management system 150 is depicted in FIG. 1 as a single entity residing on the administrative console 130 because in some examples it may be and as well as for ease of illustration.

FIG. 2 depicts selected portions of the hardware and software architecture of the administrative console 130 in the computing system 100 of FIG. 1. The administrative console 130 includes a display 200, an input device, such as the keyboard 205 and the mouse 210, a processing resource 215, a bus system 220, and a memory 225. Note that, in some examples, the input device may be a touch screen on the display 200. Instructions, including the administrative tool 140, are encoded on the memory. The processing resource 215 communicates with the memory 225, and vice versa, over the bus system 220 to execute the instructions and, among other things, implement the functionality of the administrative tool 140.

The administrative tool 140 in this particular example includes an interface 230, a knowledge base 235, and an inferencing engine 240. The interface 230 may be, for example, a graphical user interface (“GUI”) or a command line interface (“CLI”) depending upon the implementation. In operation, a user, such as the administrator 155 in FIG. 1, may enter a fuzzy logic search query for information pertaining to an operation of the computing system 100. The knowledge base 235 contains fuzzy logic rules (not separately shown) about computing system operation which reflect a knowledge and experience of system operations.

The fuzzy logic rules can be physically tailored by the administrator, e.g., one or both the function and the expressions associated with portions of the function for each metric. For example, the administrator could provide the values for X, Y, Z, etc. along with the associated expressions, described above. Furthermore, the administrator could also tailor the fuzzy logic rules applied to the individual metrics over time based either on user interaction (physical use experience and/or known performance parameters of a particular managed device).

The inferencing engine 240, in operation, applies the fuzzy logic rules of the knowledge base 235 to the information 120, shown in FIG. 1, responsive to the search query and return results through the interface 230 as described more fully below. The examples set forth herein permit an administrator or other user to search for information regarding the computing systems using fuzzy logic queries. Examples of such queries might include:

Find all “EDGE_DEVICES with LOW PORT_UTILIZATION”

Find all “PORTS with VERY HIGH PACKET_DROP and BELONG_TO VLAN 1000”

Find all “8400 DEVICES in BUILDING_4 with LOW CPU_THRESHOLD_ALERTS and HIGH TEMP”

Find all “ACCESS POINTS with VERY LOW SIGNAL_STRENGTH”

Find all “SERVERS with ABOUT 60% FREE_DISK_SPACE”

Find all “DATA_CENTERS with VERY HIGH TEMP”

Find all: “DEVICES with ABOUT the MAX_VLAN_COUNT”

Find all: “PLANS with A_LOT of FAILED_DEPLOYMENT”

Find all: “DEVICES with NOT VERY_MANY ACLS”

Note that this list of search queries is neither exhaustive nor limiting, but rather is representative of the kinds of search queries that may, be used in various embodiments.

These search queries include input variables, some of which are fuzzy logic modifiers. For instance, input variables such as “HIGH”, “VERY HIGH”, “LOW”, “VERY LOW”, “ABOUT”, “A_LOT”, and “VERY_MANY” are not crisp variables but rather are fuzzy variables. These fuzzy variables are defined by “membership functions” not shown. Consider the descriptor “TEMP”, or temperature. The descriptor “TEMP” will be associated with a membership function that defines whether a temperature quantification is “HIGH”, “VERY HIGH”, “LOW”, or “VERY LOW”. The membership functions may conveniently be included as a part of the administrative tool in each embodiment although this is not required. The inferencing engine 240 uses the membership sets to determine whether accessed information belongs to the “membership set” of the fuzzy variable.

More particularly, the fuzzy logic rules can be representative of a defined membership function, e.g., triangular, Gaussian, Bell, exponential, etc., against which an individual and/or group of measured metrics can be compared to provide a variable fuzzy rule-based expression. That is, the inferencing engine 240 can execute to inferencing on a set of fuzzy logic rules and by comparing measured metrics with the defined functions they represent. The inferencing engine 240 can then execute to produce a variable fuzzy rule-based expression based on the comparison, e.g., based on a particular measured metric fit to different portions of the function. Examples of such fuzzy rule-based expressions include, but are not limited to, “low”, “normal”, “high”, “robust”, “congested”, “good”, “bad”, “average”, “busy”, “nominal”, etc. Other variable fuzzy rule-based expressions are also possible.

Application of fuzzy logic rules may accommodate natural language rules to define a relationship between measured metrics and their range of operation according to various defined functions associated with those fuzzy logic rules. The variable fuzzy rule-based expressions then provide a more intuitive expression to a user for the assessment of such measured metrics among various managed device(s) 110. That is, the fuzzy based rule defines conditions that lead to a particular expression of information associated with each managed device, group of devices and/or the network as a whole. In various embodiments, application of the fuzzy logic rules can involve: first, defining functions for the fuzzy logic rules; second, setting the range of operation for the fuzzy logic rules associated with a particular metric, e.g., a percentage of processor usage. Each range can result in a different fuzzy rule-based expression. That is, for example, percent of processor usage between X and Y produces a fuzzy rule-based expression of “low”, between Y and Z produces a fuzzy rule-based expression of “high”, etc.

The fuzzy logic inference engine 240 can be executed to inferencing on a set of fuzzy logic rules and fuzzy logic rules the individual measured metrics in the accessed information as the metrics reflect information about a certain feature or component of a particular managed device 110. It is also possible that fuzzy logic rules can be applied to the same and/or different measured metrics from various managed devices 110. In addition, each particular measure metric can have a unique associated fuzzy based rule applied thereto. It is also possible that one associated fuzzy based rule can be used for more than one of the individual metrics.

With reference to FIG. 1 and FIG. 2 collectively, the inferencing engine 240 of the administrative tool 140 parses the search query and then applies the rules of the knowledge base 235. The accessed information 120 is then measured against the membership functions to determine the truth values of the comparison. The information meeting the membership function is then grouped into the membership set that is then presented to the user as the results of the query.

In the example of FIG. 1, the management system 150 is an application and the administrative tool 140 is integrated into the management system 150 so that it forms a constituent part thereof. However, the subject matter claimed below is not so limited. For instance, in some examples the management system 150 and the administrative tool 140 may be implemented in a single daemon. In other examples, the management system 150 and the administrative tool 140 may be separate daemons, the management system 150 being called through an interface input and the administrative tool 140 being called by the management system 150. Similarly, in other examples, the management system 150 and the administrative tool 140 may be one or separate services. If separate services, the management system 150 may call the administrative tool 140. The nature of the software in terms of whether it falls into one or more such categorizations and which categorizations those are is not material to the practice of the subject matter claimed below.

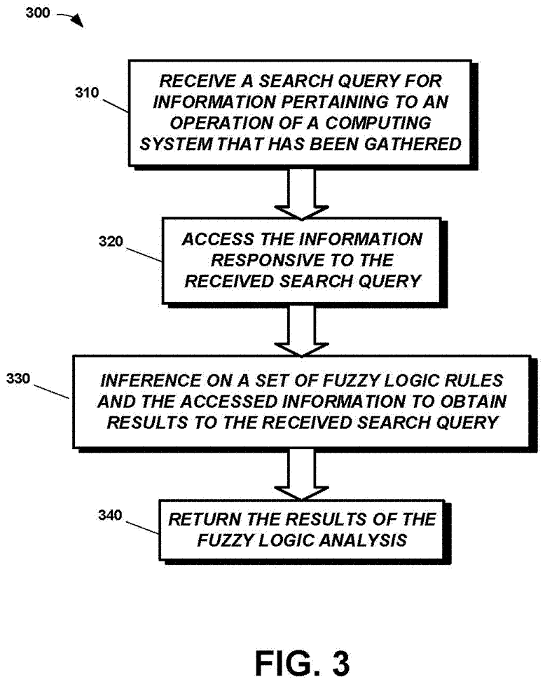

FIG. 3 illustrates a method 300 practiced in accordance with one or more examples disclosed herein. More particularly, the administrative tool 140 shown in FIG. 1 and FIG. 2, in operation through execution by the processing resource 21 in FIG. 2, performs the method 300. The method 300 begins by receiving (at 310) a search query for information pertaining to an operation of a computing system that has been gathered. The method continues then by accessing (at 320) the information 120, shown in FIG. 1, responsive to the received search query. The method 300 next applies (at 330) a fuzzy logic analysis to the accessed information 120 to obtain results to the received search query. The method 300 then returns (at 340) the results of the fuzzy logic analysis.

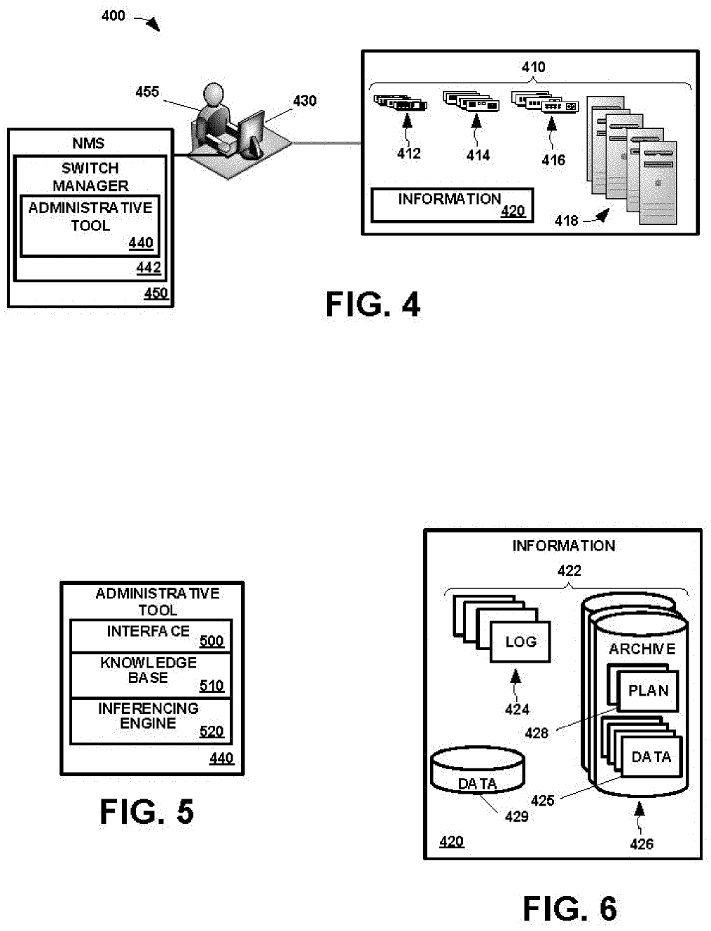

To further an understanding of that which is claimed below, another example of a computing system will now be discussed. FIG. 4 depicts one particular example of a computing system 400 operated and managed in accordance with the present disclosure. The computing system 400 is a network, which it implies that it employs certain kinds of topologies, protocols, and architectures. The precise nature of those characteristics is not material to the practice of what is claimed below. For instance, the computing system 400 may implement either a client-server or a peer-to-peer connection without materially affecting the practice of what is claimed.

The computing system 400 includes a plurality of managed devices 410, such as switches 412, bridges 414, routers 416, and servers 418, and a set of information 420. A network management system (“NMS”) 450 resides on an administrative console 430 used by a network administrator 455 to manage the resources of the computing system 400. The administrative tool 440 is, in this particular example, a part of the network management system 450. As shown in FIG. 5, the administrative tool 440 includes an interface 500, a knowledge base 510, and an inferencing engine 520. The computing system 400 also includes information 420, which as shown in FIG. 6, may include a plurality of data stores 422 to store information in a plurality of logs 424 and one or more archives 426.

Returning to FIG. 4, the network management system 450 is a suite of software applications that are used to monitor, maintain, and control the software and hardware resources of the computing system 400. Areas of responsibility for the network management system may include security, performance, and reliability. Performance and reliability may include, for instance, discovery, monitoring and management of devices as well as analysis of network performance and providing alerts and notifications. The network management system 450 therefore may include one or more applications to implement these functionalities.

The network management system 450 in this particular example therefore includes a switch manager 442 into which the administrative tool 440 may be integrated. For instance, one switch manager offered under the mark ARUBA NETEDIT™ is commercially available from Hewlett Packard Enterprises. ARUBA NETEDIT™ may be used by a network administrator to orchestrate multiple switch configurations with capabilities such as searching, editing, validation, deployment, and auditing. Using ARUBA NETEDIT™, a network administrator may configure intelligently with validation for consistency and compliance, simultaneously view and edit multiple configurations, customize validation tests for corporate compliance and network design, and automate large-scale configuration deployment without programming. ARUBA NETEDIT™ thereby permits the automation of multi-device change workflows without programming and permits network administrators smoothly coordinate end-to-end service roll outs, automate rapid network-wide changes, and ensure policy conformance after network updates. This intelligent assistance and continuous validation helps assure that network-wide configurations are consistent and compliant.

Switch managers such as ARUBA NETEDIT™ may be modified to integrate the administrative tool 440 to implement the presently claimed subject matter disclosed herein. For instance, ARUBA NETEDIT™ already includes an interface through which a network administrator interacts with the switch manager, but it is limited to “crisp” language searches. The existing, interface can be modified to accept fuzzy logic language to implement the interface 500 of the administrative tool 440. The switch manager can then be modified to call the inferencing engine 520 instead of the crisp search engine (not shown). Note that some examples may choose to implement the fuzzy logic search capability in addition to the existing crisp search capability.

The computing system 400 gathers and sometimes stores all manner of information 420 that may be accessed by the switch manager 442. For example, many switches 412 and other managed devices include a capability by which operational data may be stored in one or more logs 424. The contents of the logs 424 may occasionally be archived as data 425 in an archive 426 for longer term storage. Similarly, as alluded to above, occasionally relatively large numbers of switches 412, shown in FIG. 4, may be reconfigured at the same time. The parameter changes by which such a reconfiguration is implemented are sometimes referred to as a “plan”. Plans 428 are also generally archived. The information in the logs 424 and the archives 426 are accessible to the switch manager 442 for searching purposes.

Furthermore, the switch manager 442 may maintain a local database 429 in which it stores data related to its operations. This data may include data related to, for instance, plans, configurations, devices, topology and other such information. This information is also accessible to the switch manager 442 for searching purposes.

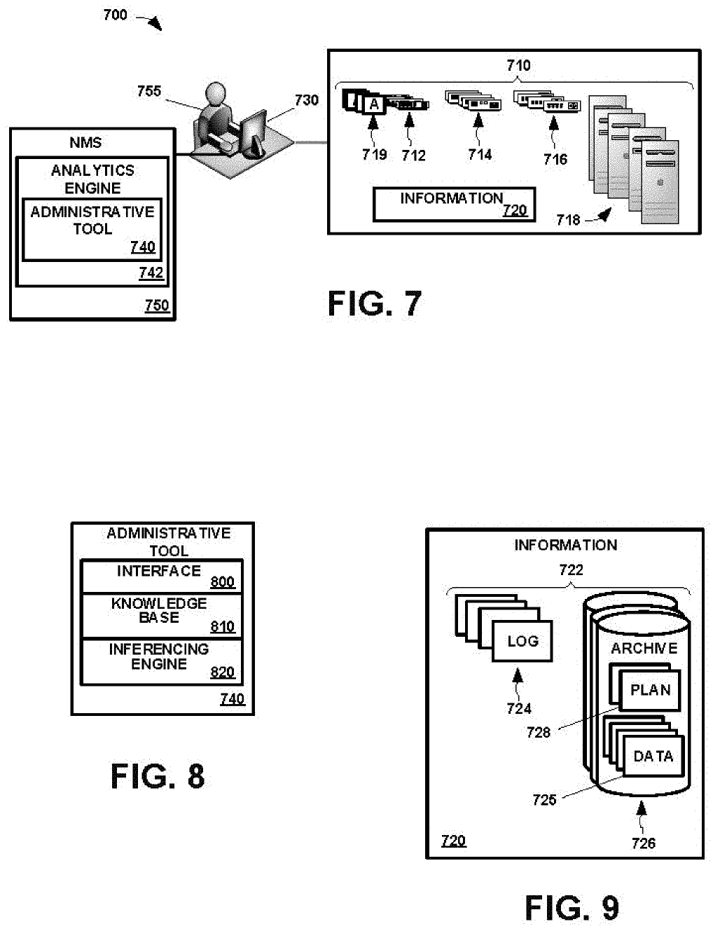

FIG. 7 depicts another particular example of a computing system 700 operated and managed in accordance with the present disclosure. The computing system 700 is also a network. The, computing system 700 includes a plurality of managed devices 710, such as switches 712, bridges 714, routers 716, and servers 718, and a set of information 720. A network management system (“NMS”) 750 resides on an administrative console 730 used by a network administrator 755 to manage the resources of the computing system 700. The administrative tool 740 is, in this particular example, a part of the network management system 750. As shown in FIG. 5, the administrative tool 740 includes an interface 800, a knowledge base 810, and an inferencing engine 820. The computing system 700 also includes information 720, which as shown in FIG. 9, may further include a plurality of data stores 722 to store information in a plurality of logs 724 and one or more archives 726.

Returning to FIG. 7, the network management system 750 is a suite of software applications that are used to monitor, maintain, and control the software and hardware resources of the computing system 700. Areas of responsibility for the network management system may include security, performance, and reliability. Performance and reliability may include, for instance, discovery, monitoring and management of devices as well as analysis of network performance and providing alerts and notifications. The network management system 750 therefore may include one or more applications to implement these functionalities.

Many networks such as the computing system 700 include analytical capabilities. Different analytical capabilities may be implemented in different ways, but for present purposes they can provide real-time data regarding the operations of managed devices. A managed device may include, for example, an agent that communicates with an analytics engine. The agent may periodically stream data to the analytic engine or report it periodically upon being polled by the analytics engine.

The network management system 750 in this particular example therefore includes an analytics engine 742 into which the administrative tool 740 may be integrated. For instance, one analytics engine is the Network Analytics Engine (“NAE”) in an analytics system offered under the mark ARUBA CX NOS™ is commercially available from Hewlett Packard Enterprises. The ARUBA CX NOS™ system includes switches with built-in monitoring capabilities. The ARUBA CX NOS™ provides default monitors, but, users may build their own using agents (programmed in PYTHON)™ that may then be uploaded into switch.

The NAE, and other analytics engines like it, may be modified to permit access to the agents and the current values of the system parameters they are monitoring, the historical time series data for those metrics, and the alerts that have been generated by the agent. In a computing system employing such a modified analytics engine will be able to search both local databases and other information storage but also real time and time series data on the switches. Thus, as shown in FIG. 7, each switch 712 includes an agent 719 that provides real time data regarding the system parameters being monitored by the analytics engine 742.

Systems using analytics engines such as ARUBA CX NOS™ may be modified to integrate the administrative tool 740 to implement the presently claimed subject matter disclosed herein. For instance, ARUBA CX NOS™ already includes an interface through which a network administrator interacts with, the analytics engine, but it is limited to “crisp” language searches. The existing interface can be modified to accept fuzzy logic language to implement the interface 800 of the administrative tool 740. The analytics engine can then be modified to call the inferencing engine 820 instead of the crisp search engine (not shown). Note that some examples may choose to implement the fuzzy logic search capability in addition to the existing crisp search capability.

The computing system 700 gathers and sometimes stores all manner of information 720 that may be accessed by the analytics engine 742. For example, many switches 712 and other managed devices include a capability by which operational data may be stored in one or more logs 724. The contents of the logs 724 may occasionally be archived as data 725 in an archive 726 for longer term storage. Similarly, as alluded to above, occasionally relatively large numbers of switches 712, shown in FIG. 7, may be reconfigured at the same time. The parameter changes by which such a reconfiguration is implemented are sometimes referred to as a “plan”. Plans 728 are also generally archived. The information in the logs 724 and the archives 726 are accessible to the analytics engine 742 for searching purposes. Note that the information 720 also includes the real-time data provided by the agents 719 to the analytics engine that are, not stored.

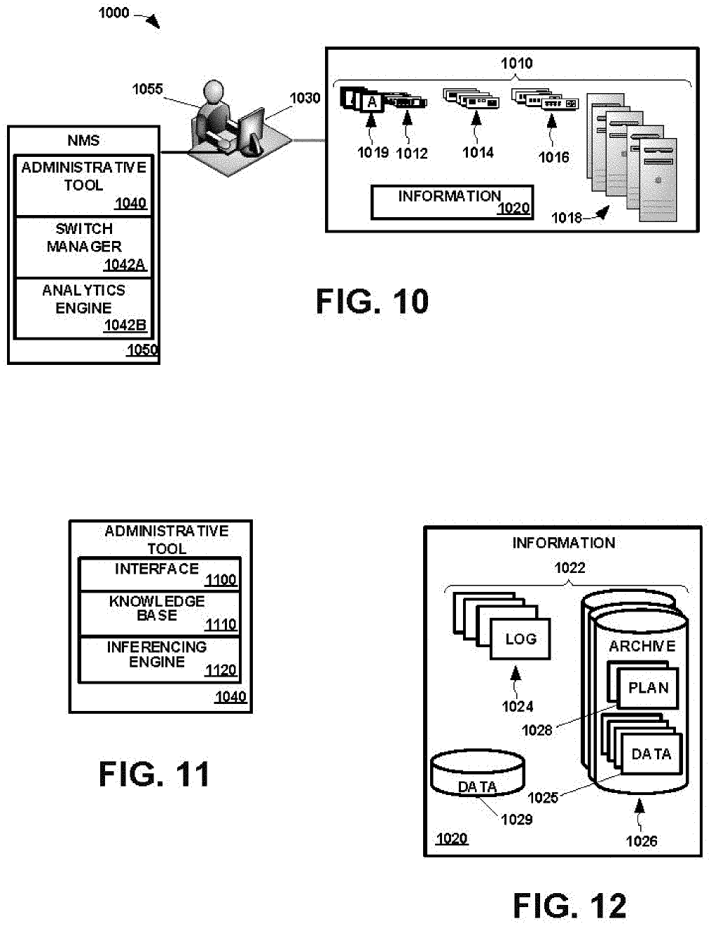

FIG. 10 depicts another particular example of a computing system 1000 operated and managed in accordance with the present disclosure. The computing system 1000 is also a network and combines the features of the computing, system 400 in FIG. 4 and the computing system 700 in FIG. 7. The computing system 1000 includes a plurality of managed devices 1010, such as switches 1012, bridges 1014, routers 1016, and servers 1018, and a set of information 1020.

A network management system (“NMS”) 1050 resides on an administrative console 1030 used by a network administrator 1055 to manage the resources of the computing system 1000. The administrative tool 1040 is, in this particular example, a part of the network management system 1050. As shown in FIG. 11, the administrative tool 1040 includes an interface 1100, a knowledge base 1110, and an inferencing engine 1120. The computing system 1000 also includes information 1020, which as shown in FIG. 12, may further include a plurality of data stores 1022 to store information in a plurality of logs 1024 and one or more archives 1026.

Returning to FIG. 10, the network management system 1050 is a suite of software applications that are used to monitor, maintain, and control the software and hardware resources of the computing system 1000. The network management system 1050 includes both a switch manager 1042A and an analytics engine 1042B. Each of the switches 1012 includes an agent 1019 as discussed above. The analytics engine 1042B can access the agents 1019 and obtain data and time series histories from them as described above.

The computing system 1000 gathers and sometimes stores all manner of information 1020 that may be accessed by the switch manger 1042A. For example, many switches 1012 and other managed devices include a capability by which operational data may be stored in one or more logs 1024. The contents of the logs 1024 may occasionally be archived as data 1025 in an archive 1026 for longer term storage. Similarly, as alluded to above, occasionally relatively large numbers of switches 1012, shown in FIG. 10, may be reconfigured at the same time. The parameter changes by which such a reconfiguration is implemented are sometimes referred to as a “plan”. Plans 1028 are also generally archived. The information in the logs 1024 and the archives 1026 are accessible to the analytics engine 1042B for searching purposes.

Note that the fuzzy logic searching disclosed herein is different in both kind and quality from what is sometimes referred to as “fuzzy searching”. Fuzzy searching is a form of crisp searching in which the interface interprets the input text for misspellings and/or imprecision. For instance, assume a user is attempting to enter a crisp search such as:

Find all “CPU>THRESHOLD”

But, in this instance, the user misspells a word in the search:

Find all “CUP>THRESHOLD”

In a fuzzy search, the interface will analyze the entered text and correct the misspelling to perform the crisp search on the language intended by the user. In this context, the term “fuzzy” denotes imprecision and inaccuracy in the input rather than anything having to do with the analysis or results. This is distinctly different from applying fuzzy logic in the execution of the search query.

The examples provided herein are all set in the context of a distributed computing system, typically one that is networked. However, some examples, some of which are not illustrated herein, may be implemented in a stand-alone computing system instead of a distributed computing system. Accordingly, the examples illustrated herein are intended to provide a context for the description of the functions and operations of the present disclosure.

The figures set forth herein aid in depicting various architectures, functionalities, and operations of the examples disclosed herein. Throughout the description, many of the elements are defined, at least in part, as programs, programming, or program instructions. Each of these elements, portions thereof, or various combinations thereof may represent in whole or in part a module, segment, or portion of code that includes one or more executable instructions to implement any specified logical function(s). Each element or various combinations thereof may represent a circuit or a number of interconnected circuits to implement the specified logical function(s).

Some portions of the detailed descriptions herein are presented in terms of a software implemented process involving symbolic representations of operations on data bits within a memory in a computing system or a computing device. These descriptions and representations are the means used by those in the art to most effectively convey the substance of their work to others skilled in the art. The process and operation require physical manipulations of physical quantities that will physically transform the particular machine or system on which the manipulations are performed or on which the results are stored. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the Ike,

It should be borne in mind, however, that all of these and similar terms are to be associated with the appropriate physical quantities and are merely convenient labels applied to these quantities. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “accessing”, “computing,” “calculating,” “determining,” “displaying,” and the like.

Furthermore, the execution of the software's functionality transforms the computing apparatus on which it is performed. For example, acquisition of data, will physically alter the content of the storage, as will subsequent processing of that data. The physical alteration is a “physical transformation” in that it changes the physical state of the storage for the computing apparatus.

The examples disclosed herein may be realized in any non-transitory, tangible computer-readable media for use by or in connection with an instruction execution system, such as a computer/processor-based system, or an Application Specific Integrated Circuit (“ASIC”), or another system that can fetch or obtain the logic from computer-readable media and execute the instructions contained therein. Non-transitory, tangible computer-readable media may be any media that is capable of containing, storing, or maintaining programs and data for use by or in connection with the computing systems disclosed herein. Computer readable media may include any one of many physical media such as, for example, electronic, magnetic, optical, electromagnetic, or semiconductor media.

More specific examples of suitable computer-readable media include a portable magnetic computer diskette such as floppy diskettes or hard drives, a random access memory (“RAM”), a read-only memory (“ROM”), an erasable programmable read-only memory (“EPROM”), or a portable compact disk (“CD”), digital video disk (“DVD”), or flash drive. Similarly, the transmission medium may be twisted wire pairs, coaxial cable, optical fiber, or some other suitable transmission medium known to the art. The technique is not limited by these aspects of any given implementation.

This concludes the detailed description. The particular examples disclosed above are illustrative only, as examples described herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular examples disclosed above may be altered or modified and all such variations are considered within the scope and spirit of the appended claims. Accordingly, the protection sought herein is as set forth in the claims below.

What is claimed is:

1. A computing system, comprising:
a plurality of managed devices;
a set of information, the information including operating information for the managed devices; and
an administrative tool, including:
an interface through which, in operation, a user may enter a search query for information pertaining to the operation of the managed devices;
a knowledge base containing fuzzy logic rules about the operation of the managed devices; and
an inferencing engine that, in operation, applies the fuzzy logic rules to the information responsive to the search query and return results through the interface.

2. The computing system of claim 1, wherein the information includes at least one of real-time information and stored information.

3. The computing system of claim 2, wherein the information includes the real-time information, and the real-time information includes at least one of solicited information and unsolicited information.

4. The computing system of claim 2, wherein the information includes the stored information, and the stored information includes at least one of logged data and archived plans.

5. The computing system of claim 1, further comprising a management system.

6. The computing system of claim 5, wherein management system is a network management system.

7. The computing system of claim 5, wherein the administrative tool is a portion of the management system.

8. The computing system of claim 5, wherein the management system includes an analytics engine.

9. The computing system of claim b, wherein the management system includes a switch manager.

10. A method, comprising:
receiving a search query for information pertaining to an operation of a computing system that has been gathered;
accessing the information responsive to the received search query;
inferencing on a set of fuzzy logic rules and the accessed information, to obtain, results to the received search query; and
returning the results of the fuzzy logic analysis.

11. The method of claim 10, wherein the information is at least one of real-time information and stored information.

12. The method of claim 11, wherein the information includes the real-time inforrnation, and the real-time information includes at least one of solicited information and unsolicited information.

13. The method of claim 11, wherein the information includes the stored information, and the stored information includes at least one of logged data and archived plans.

14. The method of claim 10, wherein the information is further pertinent to the management of at least one switch.

15. The method of claim 10, wherein the information is further pertinent to analytics of the computing system.

16. An administrative console, including:
a display;
an input device;
a processing resource;
a bus system; and
a memory communicating with the processing resource over the bus system and on which are encoded instructions that, when executed by the processing resource, cause the processing resource to:
receive a search query for information pertaining to an operation of a computing system that has been gathered, the search query being input using the display and the input device;
access the information responsive to the received search query;
inferencing on a set of fuzzy logic rules and the accessed information to obtain results to the received search query; and
return the results of the inferencing.

17. The administrative console of claim 16, wherein the information is at least one of real-time information and stored information.

18. The administrative console of claim 17, wherein the information includes the real-time information, and the real-time information includes at least one of solicited information and unsolicited information.

19. The administrative console of claim 17, wherein the information includes the stored information, and the stored information includes at least one of logged data and archived plans.

20. The administrative console of claim 16, wherein the information is further pertinent to the management of at least one switch.

21. The administrative console of claim 16, wherein the information is further pertinent to analytics of the computing system.
